(19) United States
(12) Patent Application Publication
(10) Pub. No.: US 2026/0280182 A1
(43) Pub. Date: Sep. 17, 2026

(54) ELECTRICAL CONNECTOR FOR DOOR LOCK CAMERA

(71) Applicant: DongGuan SUNGTECH Electronics Co., LTD., Dongguan (CN)

(72) Inventor: Weicheng QIU, Dongguan (CN)

(21) Appl. No.: 19/078,498

(22) Filed: Mar. 13, 2025

(51) Int. Cl. H01R 13/52; G06F 13/42; H01R 13/66

(52) U.S. Cl. CPC H01R 13/5213; H01R 13/6675; G06F 13/4282; G06F 2213/0042

(57) ABSTRACT

Provided is an electrical connector for a door lock camera, which relates to the technical field of electrical connection structures. The electrical connector includes a connector female end and a connector male end. The connector female end includes a controller and a camera connector for connecting a camera. The controller is connected with the camera connector through wires. The controller is provided with a power supply module, a control circuit board and a Universal Serial Bus (USB) interface. The connector male end includes a USB connector, a step-down transformer and a plug. The USB connector is connected with the step-down transformer and the plug through wires. The USB connector is adaptively plugged into the USB interface to electrically connect the connector female end and the connector male end. The connector female end further includes a waterproof sleeve.

### TECHNICAL FIELD

The present disclosure relates to the technical field of electrical connection structures, and in particular to an electrical connector for a door lock camera.

### BACKGROUND

With the popularity of face recognition, a door lock is also provided with a camera for face recognition and unlocking. The camera has a voltage of 5V when being powered on, and the household circuit usually has a voltage of 12V. Therefore, when a door lock camera is required, it is necessary for the technicians or staff members of the power supply bureau to come to the door to re-lay the wires before the door lock camera can be installed. Therefore, it is very inconvenient and time-consuming to install a door lock camera.

With the increase of the market demand, a connector is usually provided with waterproof characteristics. Most of the existing connectors achieve a waterproof effect through a tight connection of the housing. Although this method has achieved a waterproof effect, since the entire housing is airtight, the electronic components inside the housing cannot dissipate heat properly. As a result, the performance of the connector will be affected.

### SUMMARY

In order to solve the above technical problems, the present disclosure proposes the following optimization technical scheme.

An electrical connector for a door lock camera is provided, including a connector female end and a connector male end, wherein the connector female end includes a controller and a camera connector for connecting a camera, the controller is connected with the camera connector through wires, the controller is provided with a power supply module, a control circuit board and a Universal Serial Bus (USB) interface, the connector male end includes a USB connector, a step-down transformer and a plug, the USB connector is connected with the step-down transformer and the plug through wires, and the USB connector is adaptively plugged into the USB interface to electrically connect the connector female end and the connector male end; the connector female end further includes a waterproof sleeve, the waterproof sleeve is provided with a plugging end, the plugging end is plugged into the USB interface to connect the waterproof sleeve to an opening of the USB interface, the waterproof sleeve is provided with a connecting strip, one end of the connecting strip is connected with the controller, and the other end thereof is connected with the waterproof sleeve.

Further, an inner wall of the waterproof sleeve is provided with an anti-dropping protrusion, the USB connector is provided with an anti-dropping groove, and the USB connector is plugged into the USB interface so that the anti-dropping protrusion is clamped into the anti-dropping groove.

Further, the anti-dropping protrusion has a structure with a narrow top and a wide bottom, and the surface of the anti-dropping protrusion is a cambered surface.

Further, the waterproof sleeve is made of rubber.

Further, the control circuit board is provided with a voltage stabilizing module.

Further, an outer wall of the connector female end is provided with a protruding strip.

Compared with the prior art, the present disclosure has the following beneficial effects.
1. The present disclosure discloses a connector female end and a connector male end, which are electrically connected through a USB interface. The connector female end is connected with a camera, and the connector male end is provided with a step-down transformer. The step-down transformer reduces the household voltage from 12V to 5V, so that the connector male end can be directly connected with a household socket through a plug, without separately calling in staff members or technicians to lay additional wires. The installation work is simplified, the installation is more convenient, and the waterproof sleeve is flexibly plugged into the connector female end, so that the use experience is better. 2. The connector female end is provided with a waterproof sleeve. The plugging end of the waterproof sleeve is plugged into the opening of the USB interface, that is, the waterproof sleeve has the characteristics of being easy to plug in and unplug. When water leakage may occur, the waterproof sleeve is plugged into the opening of the USB interface, so as to be waterproof. When the connector is in a safe position where water does not appear, the waterproof sleeve can be pulled out to facilitate the heat dissipation of the connector. The waterproof sleeve is connected to the controller through the connecting strip, so that the waterproof sleeve can be effectively prevented from being lost.

### BRIEF DESCRIPTION OF THE DRAWINGS

FIG. 1 is a first schematic structural diagram of the present disclosure.

FIG. 2 is a second schematic structural diagram of the present disclosure.

FIG. 3 is a third schematic structural diagram of the present disclosure.

FIG. 4 is a schematic structural diagram of a connector female end according to the present disclosure.

FIG. 5 is a circuit diagram of a control circuit board according to the present disclosure.

In the figures: 1. Connector female end; 2. Connector male end; 3. Controller; 4. USB connector; 5. Wire; 6. Waterproof sleeve; 7. Plugging end; 8. Anti-dropping groove; 9. Connecting strip; 10. USB interface; 11. Protruding strip.

### DETAILED DESCRIPTION OF THE EMBODIMENTS

In order to make the purpose, the technical scheme and the advantages of the embodiment of the present disclosure clearer, the technical scheme in the embodiment of the present disclosure will be described clearly and completely with reference to the attached drawings. Obviously, the described embodiments are some of the embodiments of the present disclosure, rather than all of the embodiments. Based on the embodiments in the present disclosure, all other embodiments obtained by those skilled in the art without paying creative labor belong to the scope of protection of the present disclosure.

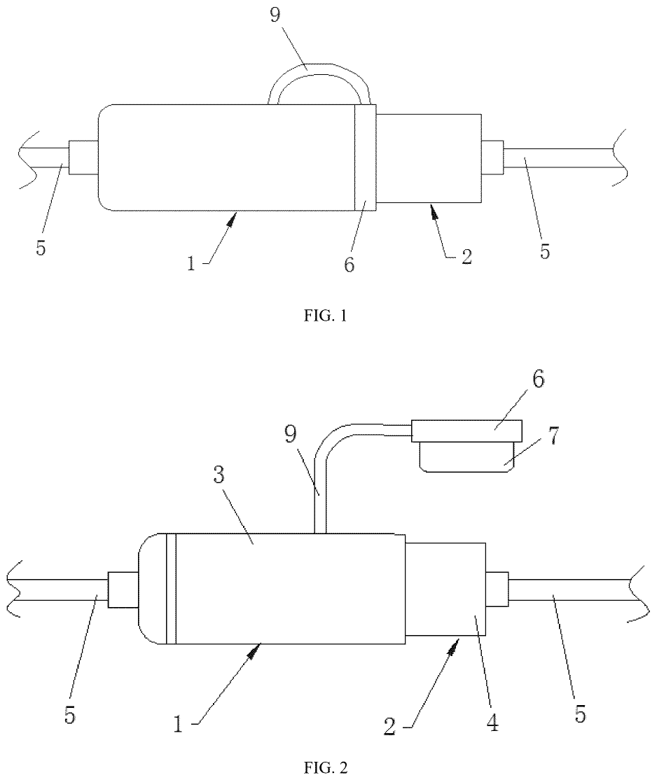

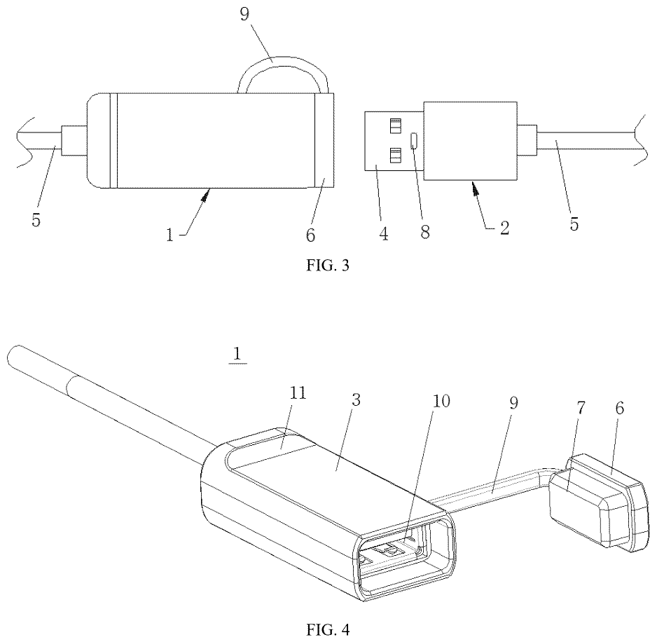

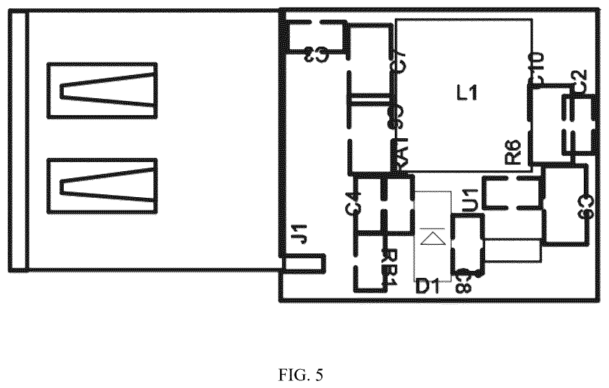

As shown in FIG. 1 to FIG. 5, an electrical connector for a door lock camera includes a connector female end 1 and a connector male end 2. The connector female end 1 includes a controller 3 and a camera connector for connecting a camera. The controller 3 is connected with the camera connector through wires 5. The controller 3 is provided with a power supply module, a control circuit board and a USB interface 10. The connector male end 2 includes a USB connector 4, a step-down transformer and a plug. The USB connector 4 is connected with the step-down transformer and the plug through wires 5. The USB connector 4 is adaptively plugged into the USB interface 10 to electrically connect the connector female end 1 and the connector male end 2.

In the above technical mode, the camera connector is plugged into the connection interface of the camera to electrically connect the connector female end 1 and the camera. The USB connector 4 is plugged into the USB interface 10 to electrically connect the connector female end 1 and the connector male end 2. The plug is plugged into the household socket to electrify the camera, wherein the step-down transformer reduces the voltage of the household socket from 12V to 5V, so that the household voltage can be matched with the voltage required by the camera. Electricity can be directly used. Technicians do not need to come to the door to pull the wires 5, thus simplifying the installation work.

In this embodiment, the connector female end 1 further includes a waterproof sleeve 6. The waterproof sleeve 6 is provided with a plugging end 7. The plugging end 7 is plugged into the USB interface 10 to connect the waterproof sleeve 6 to an opening of the USB interface 10. Specifically, the plugging end 7 is tightly plugged into the opening of the USB interface 10. The USB connector 4 is plugged into the USB interface 10 after passing through the waterproof sleeve 6. The waterproof sleeve 6 plays a waterproof role between the USB connector 4 and the USB interface 10, which prevents water from entering between the USB connector 4 and the USB interface 10 and facilitates plugging and unplugging the waterproof sleeve 6. When water leakage may occur, the waterproof sleeve 6 is plugged into the opening of the USB interface 10, so as to be waterproof. The waterproof sleeve 6 can be unplugged when the connector is in a safe position where water does not appear, so as to facilitate the heat dissipation of the connector.

In this embodiment, the waterproof sleeve 6 is provided with a connecting strip 9. One end of the connecting strip 9 is connected with the controller 3, and the other end thereof is connected with the waterproof sleeve 6. The connecting strip 9 is used to connect the waterproof sleeve 6 to the controller 3 to avoid losing the waterproof sleeve 6 when disassembling the waterproof sleeve 6.

In this embodiment, an inner wall of the waterproof sleeve 6 is provided with an anti-dropping protrusion. The USB connector 4 is provided with an anti-dropping groove 8. The USB connector is plugged into the USB interface 10 so that the anti-dropping protrusion is clamped into the anti-dropping groove 8, which plays an anti-dropping role.

In this embodiment, the anti-dropping protrusion 8 has a structure with a narrow top and a wide bottom, and the surface of the anti-dropping protrusion 8 is a cambered surface. When manually plugging and unplugging the USB connector, because the surface of the anti-dropping protrusion 8 is a cambered surface, it is more convenient to unplug and plug the USB connector.

In this embodiment, the waterproof sleeve 6 is made of rubber, which is flexible to some extent, excellent in sealing effect and waterproof.

In this embodiment, the control circuit board is provided with a voltage stabilizing module, and the voltage stabilizing module has a voltage stabilizing effect on the circuit.

In this embodiment, an outer wall of the connector female end is provided with a protruding strip 11. When plugging and unplugging the connector male end 2, the protruding strip 11 is grabbed by hand, which is convenient to apply a force and plug and unplug the connector female end 1 and the connector male end 2.

What has been described above is only the detailed description of the present disclosure, which enables those skilled in the art to understand or realize the present disclosure. Many modifications to these embodiments will be obvious to those skilled in the art. The general principles defined herein can be implemented in other embodiments without departing from the spirit or scope of the present disclosure. Therefore, the present disclosure is not to be limited to the embodiments shown herein, but is to be accorded the broadest scope consistent with the principles and novel features applied herein.

1. An electrical connector for a door lock camera, comprising a connector female end and a connector male end, wherein the connector female end comprises a controller and a camera connector for connecting a camera, the controller is connected with the camera connector through wires, the controller is provided with a power supply module, a control circuit board and a Universal Serial Bus (USB) interface, the connector male end includes a USB connector, a step-down transformer and a plug, the USB connector is connected with the step-down transformer and the plug through wires, and the USB connector is adaptively plugged into the USB interface to electrically connect the connector female end and the connector male end;
the connector female end further comprises a waterproof sleeve, the waterproof sleeve is provided with a plugging end, the plugging end is plugged into the USB interface to connect the waterproof sleeve to an opening of the USB interface, the waterproof sleeve is provided with a connecting strip, one end of the connecting strip is connected with the controller, and the other end thereof is connected with the waterproof sleeve.

2. The electrical connector for the door lock camera according to claim 1, wherein an inner wall of the waterproof sleeve is provided with an anti-dropping protrusion, the USB connector is provided with an anti-dropping groove, and the USB connector is plugged into the USB interface so that the anti-dropping protrusion is clamped into the anti-dropping groove.

3. The electrical connector for the door lock camera according to claim 2, wherein the anti-dropping protrusion has a structure with a narrow top and a wide bottom, and the surface of the anti-dropping protrusion is a cambered surface.

4. The electrical connector for the door lock camera according to claim 1, wherein the waterproof sleeve is made of rubber.

5. The electrical connector for the door lock camera according to claim 1, wherein the control circuit board is provided with a voltage stabilizing module.

6. The electrical connector for the door lock camera according to claim 1, wherein an outer wall of the connector female end is provided with a protruding strip.
